(19) United States
(12) Patent Application Publication
(10) Pub. No.: US 2011/0195288 A1
(43) Pub. Date: Aug. 11, 2011

(54) SEALED BATTERY AND METHOD FOR FABRICATING THE SAME

(76) Inventors: Yukio Harima, Osaka (JP); Seiji Kumazawa, Osaka (JP); Koji Funami, Kyoto (JP); Takahiro Fukuoka, Osaka (JP); Kyosuke Miyata, Osaka (JP); Seiichi Kato, Osaka (JP)

(21) Appl. No.: 13/123,765

(22) PCT Filed: Jul. 27, 2010
(86) PCT No.: PCT/JP2010/004766

§ 371 Date: Apr. 12, 2011

(30) Foreign Application Priority Data
Aug. 5, 2009 (JP) 2009-182155

(51) Int. Cl. H01M 2/26; H01M 2/04; B23K 26/20

(52) U.S. Cl. 429/94; 429/181; 29/623.1; 219/121.64

(57) ABSTRACT

A sealed battery includes electrode group 4 formed by winding or stacking a positive electrode plate 1 and a negative electrode plate 2 with a separator 3 interposed between the positive electrode plate 1 and the negative electrode plate 2, the electrode group being housed in a battery case 5, and an opening of the battery case 5 being sealed with a sealing plate 10, wherein a lead 11 extending from one of the electrode plates in the electrode group 4 is laser welded to the sealing plate 10, and a welding portion 14 between the lead 11 and the sealing plate 10 has a linear shape straddling at least an end portion of the lead 11.

### TECHNICAL FIELD

The present invention relates to sealed batteries and methods for fabricating the same, and more particularly to a joint structure between a sealing plate and a lead extending from an electrode group.

### BACKGROUND ART

In recent years, sealed batteries have widely been used. Examples of such sealed batteries include aqueous electrolyte batteries typified by high-capacity alkaline storage batteries and nonaqueous electrolyte batteries typified by lithium-ion batteries which are increasingly used as power sources for driving portable electronic devices or other devices. Moreover, with increase of functions of the electronic devices and communication devices in recent years, sealed batteries with higher capacity have been in demand. As the capacity of the sealed batteries increases, measures for safety are to be emphasized. In particular, internal short-circuits, or the like in sealed batteries may cause a rapid temperature rise, which may lead to thermal runaway. Thus, it is strongly demanded to improve the safety. In particular, large-size, high-power sealed batteries require the technique of, for example, reducing the thermal runaway in order to improve the safety.

These sealed batteries have a sealed structure in which an electrode group formed by winding or stacking a positive electrode plate and a negative electrode plate with a separator interposed between the positive electrode plate and the negative electrode plate is housed in a battery case together with an electrolyte, and in which an opening of the battery case is sealed with a sealing plate with a gasket sandwiched between the opening and the sealing plate. In this structure, a lead extending from one of the electrode plates (e.g., the positive electrode plate) in the electrode group is connected to the sealing plate serving as an external terminal at one side, whereas a lead extending from the other electrode plate (e.g., the negative electrode plate) in the electrode group is connected to an inner surface of the battery case serving as an external terminal at the other side. To connect the lead to the sealing plate or to the inner surface of the battery case, resistance welding is widely employed.

The opening of the battery case is sealed by resistance-welding the lead extending from the electrode group to the sealing plate, with the electrode group being housed in the battery case, and then bending the lead to be housed in the battery case to seal the opening of the battery case with the sealing plate. In this process, while the lead extending from the electrode group is resistance-welded to the sealing plate, substances (mainly metal particles removed from a welding portion of the lead) can be sputtered. If these sputtered substances enter the electrode group in the battery case, the separator might be damaged, resulting in an internal short-circuit. In another case where sputtered substances adhere to the gasket joined to the periphery of the sealing plate, when the opening of the battery case is sealed with the sealing plate by crimping with a gasket sandwiched between the opening and the sealing plate, a portion of the gasket narrowed by crimping might be sheared by the sputtered substances. Consequently, the battery case and the sealing plate come into contact with each other while sandwiching the sputtered substances therebetween, resulting in a short circuit.

To prevent such a short circuit caused by, for example, contamination by sputtered substances, the opening of a battery case may be covered with a thin plate or the like during production so as to prevent sputtered substances from entering the battery case, for example, during resistance welding of the lead extending from the electrode group to the sealing plate. However, the opening cannot be completely covered, and thus, such covering is insufficient for preventing contamination by sputtered substances.

On the other hand, joining by ultrasonic welding, instead of resistance welding, does not cause melting as caused by the resistance welding, and thus contamination by sputtered substances can be prevented in principle. However, joining by ultrasonic welding exhibits a lower joint strength than that obtained by the resistance welding. In addition, if the sealing plate has a safety mechanism for explosion protection, ultrasonic vibration might affect the function of the safety mechanism, or might cause peeling off of an active material from the electrode plate. Thus, joining by the ultrasonic welding is not preferable in reliability.

Since aluminum is generally used as a material for current collectors of positive electrode plates of lithium ion secondary batteries, the leads extending from the positive electrode plates also use aluminum. In addition, to reduce the weight of batteries, the battery cases and the sealing plates have begun to use aluminum. In this case, welding between the lead and the sealing plate means connection between aluminum components. In general, aluminum has a higher electric conductivity and a higher thermal conductivity than those of steel. Accordingly, a large current needs to flow for a short period in resistance welding of aluminum components, resulting in that a welding rod used in the resistance welding wears worse in aluminum welding than in steel welding, and it is difficult to maintain stable welding for a long period.

To prevent this problem, laser welding using a pulse oscillation YAG laser which is capable of locally concentrating energy is employed for welding between the lead and the sealing plate. Since a laser beam can be narrowed in the laser welding, the melted area can be smaller in the laser welding than in the resistance welding. Accordingly, the amount of sputtered substances can be reduced.

As an example of welding by using a pulse oscillation YAG laser, a method has been proposed in which as illustrated in FIG. 6, a sealing plate 101 sealing an opening of a battery case in which an electrode plate group 41 including a positive electrode plate, a negative electrode plate, and a separator interposed between the positive electrode plate and the negative electrode plate is stored is welded to a lead 111 extending from the electrode plate group 41 at continuous two or more points by using a laser to increase the tensile strength of welding portions 142, thereby improving the reliability of the battery (for example, see PATENT DOCUMENT 1).

Alternatively, another method has been proposed in which as illustrated in FIG. 7, a lead 111 extending from an electrode plate group formed by stacking a positive electrode plate and a negative electrode plate with a separator interposed between the positive electrode plate and the negative electrode plate is joined to a sealing plate 101 at two or more points in the width direction of the lead 111 and also at two or more points in the longitudinal direction of lead 111 by using a laser, thereby forming two lines of welding portions 142, which improves the joint strength between the lead 111 and the sealing plate 101 (for example, see PATENT DOCUMENT 2).

### CITATION LIST

### Patent Document

PATENT DOCUMENT 1: Japanese Patent Publication No. 2000-299099

PATENT DOCUMENT 2: Japanese Patent Publication No. 2007-234276

### SUMMARY OF THE INVENTION

### Technical Problem

However, in the conventional techniques described in PATENT DOCUMENTS 1 and 2, a reliability test, including a strength test, performed on lithium-ion secondary batteries for each of which a lead and a sealing plate were joined by welding using a pulse oscillation YAG laser, showed a certain proportion of lithium ion secondary batteries in which heat was generated probably because of short circuiting. In order to reduce internal short circuits, the inventors of the present application have conducted various studies on welding between a lead extending from an electrode group and a sealing plate, and have found the following problems.

A further examination of the lithium ion secondary batteries in which heat was generated showed that an internal short circuit was caused by a short circuit occurring between the opening of the battery case and the sealing plate due to shearing of the gasket and damage on the separator. This phenomenon was analyzed, and it was found that foreign substances which have caused the short circuit contained aluminum as materials for the lead and the sealing plate.

In view of this result, it was found that sputtering was caused by variations in some external factors in fabrication processes during laser welding between the lead extending from the electrode plate group and the sealing plate, and the sputtered substances adhered to the gasket or entered the battery case. Irradiation of an end portion of the lead with the laser beam produces a large amount of the sputtered substances due to variations in position of the lead extending from the electrode plate group or variations in position of irradiation with the laser beam.

A method for laser welding a lead to a sealing plate by using a pulse oscillation YAG laser in a conventional technique is illustrated in FIGS. 5A-5F. FIGS. 5A-5C are cross-sectional views, and FIGS. 5D-5F are top views.

As illustrated in FIG. 5A, a lead 111 is brought into contact with a sealing plate 101 such that no gap is formed between the lead 111 and the sealing plate 101. As illustrated in FIG. 5D, the lead 111 is disposed such that an end portion of the lead 111 is in contact with the sealing plate 101 near the center of the sealing plate 101.

Next, as illustrated in FIG. 5B, irradiation with a laser beam 121 is started from a surface of the lead 111 in a direction of the sealing plate in contact with the lead 111, thereby forming a melted portion 151. As illustrated in FIG. 5E, laser welding is performed on the lead 111 near the center of the sealing plate 101, thereby forming the melted portion 151 in the lead 111.

Next, as illustrated in FIG. 5C, the lead 111 is scanned with the laser beam 121 in its width direction while the lead 111 is irradiated with the laser beam 121. Here, only the surface of the lead 111 is irradiated with the laser beam 121 so that the melted portion 151 is formed. The melted portion 151 solidifies, thereby form a welding portion 141. FIG. 5F illustrates the positional relationship between the melted portion 151 formed by the laser welding and the welding portion 141 formed by solidifying the melted portion 151 in the lead 111 near the center of the sealing plate 101.

Here, YAG lasers includes a continuous-wave (CW) YAG laser configured to produce continuous oscillation of a laser beam, and a YAG laser configured to produce pulse oscillation of a laser beam. Both of these lasers are capable of welding the lead to the sealing plate. However, since the pulse oscillation YAG laser is configured to store energy and to momentarily discharge the energy, the average power of the YAG laser can be reduced compared to the CW YAG laser. Moreover, since the heat dissipation of the pulse oscillation YAG laser is larger than that of the continuous wave (CW) YAG laser, the pulse oscillation YAG laser is generally used for the reason that the temperatures of the melted portion at the beginning and the end of welding can easily be adjusted to the same temperature during scanning. The pulse oscillation YAG laser will further be described.

The light collection ability of the pulse oscillation YAG laser is lower than that of a fiber laser used in the present invention. Thus, the spot diameter of a laser beam of the YAG laser at a working point of an optical system, including an optical fiber and a condenser lens, used for welding is larger than that of the fiber laser by an order of magnitude, and is about 0.3-0.8 mm in practice, which is greater than or equal to the thickness of the lead 111. In FIGS. 5B and 5E, when irradiation of an end of the lead 111 with the laser beam 121 is started, the melted portion 151 is formed in a large region at the end of the lead 111. Here, since heat at a center portion of the melted portion 151 cannot be dissipated into peripheral portions, the temperature of the center portion of the melted portion 151 rapidly rises, so that melted metal is partially sputtered, thereby producing sputtered substances 131. If a large amount of the sputtered substances is produced, a hole 161 as illustrated in FIGS. 5C, 5F may be formed.

As described above, when the lead 111 is welded to the sealing plate 101 by using the pulse oscillation YAG laser in which the spot diameter of the laser beam 121 is larger than or equal to the thickness of the lead 111, the sputtered substances 131 are necessarily produced when irradiation is performed outside the lead 111 irrespectively of the beginning, the middle, or the ending of the irradiation process. In particular, when the irradiation is performed on the end of the lead 111, the amount of the sputtered substances 131 is large. Therefore, as illustrated in FIGS. 5B and 5E, the laser welding is performed only on the surface of the lead 111. In order to prevent the production of the sputtered substances 131, the irradiation is not performed on the surface of the lead 111 from end to end, but it is attempted to achieve stable welding in a small region of the surface of the lead 111. In this case, the welding length is short, and thus the joint strength is reduced. Accordingly, the lead 111 may be detached from the sealing plate 101 due to vibration or the like, and the battery may no longer perform its function.

Therefore, in order to ensure the function of the sealed battery, the welding length has to be long. For this purpose, it is necessary that the lead 111 is irradiated with a laser from a position close to one end of the lead 111 to a position close to the opposite end of the lead 111. However, due to variations in position of the lead 111, or variations in position of irradiation with the laser, the irradiation may be performed on the end of the lead 111. Thus, it was difficult to reduce the sputtered substances 131, and there was a problem that a large number of defects are caused.

It is therefore a main object of the present invention to provide a stable, highly reliable sealed battery by reducing the influence of sputtering during laser welding between a lead and a sealing plate without forming a hole and without reducing the joint strength.

### SOLUTION TO THE PROBLEM

To achieve the above object, a sealed battery of the present invention is a sealed battery in which an electrode group formed by winding or stacking a positive electrode plate and a negative electrode plate with a separator interposed between the positive electrode plate and the negative electrode plate is housed in a battery case, and an opening of the battery case is sealed with a sealing plate, wherein a lead extending from one of the electrode plates in the electrode group is laser welded to the sealing plate, and a welding portion between the lead and the sealing plate has a linear shape straddling at least an end portion of the lead.

### ADVANTAGES OF THE INVENTION

According to the present invention, even with a variation in external factors in fabrication processes, for example, variations in position of the lead or variations in position of irradiation with a laser, in laser welding between the lead and the sealing plate, a joint strength between the lead and the sealing plate can be maintained with sputtering during the laser welding being significantly reduced without forming a hole in the lead. In this manner, a stable, highly reliable sealed battery with reduced contamination by sputtered substances can be obtained.

### BRIEF DESCRIPTION OF THE DRAWINGS

FIG. 1 is a cross-sectional view schematically illustrating a configuration of a sealed battery of an embodiment of the present invention.

FIG. 2A is a cross-sectional view illustrating a laser joint portion of the embodiment of the present invention.

FIG. 2B is a plan view illustrating the laser joint portion.

FIGS. 3A-3C are cross-sectional views illustrating processes of laser welding between the lead and the sealing plate of the embodiment of the present invention.

FIGS. 3D-3F are plan views illustrating the processes of FIGS. 3A-3C, respectively.

FIGS. 4A-4F are plan views illustrating configurations of welding portions between leads and sealing plates in other embodiments of the present invention.

FIGS. 5A-5C are cross-sectional views illustrating processes of laser welding between a lead and a sealing plate by using a conventional pulse oscillation YAG laser.

FIGS. 5D-5F are plan views illustrating the processes of FIGS. 5A-5C, respectively.

FIG. 6 is a partial schematic view illustrating a conventional configuration of a battery including a lead laser welded to a sealing plate.

FIG. 7 is an enlarged view of a part illustrating a conventional configuration of welding portions between the lead and the sealing plate.

### DESCRIPTION OF EMBODIMENTS

A sealed battery of the present invention is a sealed battery in which an electrode group formed by winding or stacking a positive electrode plate and a negative electrode plate with a separator interposed between the positive electrode plate and the negative electrode plate is housed in a battery case, and an opening of the battery case is sealed with a sealing plate, wherein a lead extending from one of the electrode plates in the electrode group is laser welded to the sealing plate, and a welding portion between the lead and the sealing plate has a linear shape straddling at least an end portion of the lead. With this configuration, sputtered substances during the laser welding can significantly be reduced, and the joint strength between the lead and the sealing plate can be increased. As a result, it is possible to obtain a stable and highly reliable sealed battery with a reduced number of holes formed in the lead.

Here, the lead is preferably laser welded to the sealing plate by being continuously scanned with a laser beam having a spot diameter smaller than the thickness of the lead. With this configuration, it is possible to obtain a highly reliable sealed battery having an increased joint strength between the lead and the sealing plate, wherein formation of a hole in the lead and sputtered substances are reduced.

Moreover, the ratio of the welding length to the welding width of the welding portion is preferably greater than or equal to four. With this configuration, it is possible to obtain a sealed battery having a high joint strength.

Moreover, the lead and the sealing plate are preferably made of a material containing aluminum as a main component. Since the material containing aluminum as a main component has a high thermal conductivity, an excessive temperature rise is reduced by heat conduction, thereby reducing sputtered substances, which can lead to an early solidification of a melted portion. Moreover, the material containing aluminum as a main component has a high electric conductivity, and thus it is possible to obtain a highly reliable sealed battery which has increased efficiency of current collection, is light in weight, and has an improved joint strength.

A method for fabricating a sealed battery according to the present invention includes: forming an electrode group by winding or stacking a positive electrode plate and a negative electrode plate with a separator interposed between the positive electrode plate and the negative electrode plate; connecting one end of a lead to one of the electrode plates in the electrode group; housing the electrode group in a battery case; laser welding the other end of the lead to a sealing plate by applying, to the lead, a laser beam having a spot diameter smaller than a thickness of the lead while continuously scanning the lead with the laser beam, with the other end brought into contact with the sealing plate; and sealing an opening of the battery case with the sealing plate, wherein the scanning with the laser beam starts at least from a surface of the sealing plate and reaches a surface of the lead via an end portion of the lead. With this method, even with a variation in external factors in fabrication processes in welding between the lead and the sealing plate, a joint strength between the lead and the sealing plate can be maintained with formation of a hole in the lead being reduced and with sputtered substances being significantly reduced during the laser welding. As a result, it is possible to fabricate a highly reliable sealed battery with reduced contamination by the sputtered substances.

Here, a light source of the laser beam is preferably a fiber laser. With this method, it is possible to easily obtain a laser beam having a spot diameter smaller than the thickness of the lead. Thus, it is possible to reduce formation of a hole in the lead and to reduce sputtered substances entering in the battery.

Moreover, a distance scanned with the laser beam per second is preferably 2500 or more times the spot diameter of the laser beam. With this method, when the surface of the sealing plate disposed outside the lead is irradiated with the laser beam, heat input per unit time can be reduced. Thus, the melted portion does not reach a back side of the sealing plate, but the joint strength can be increased.

Moreover, the scanning speed of the laser beam is preferably higher in scanning the surface of the sealing plate than in scanning the surface of the lead. In this method, when the surface of the sealing plate whose temperature easily rises due to its small heat capacity is irradiated with the laser beam, heat input can be reduced. Thus, it is possible to prevent the melted portion from reaching the back side of the sealing plate. Alternatively, in order to obtain similar advantages, the output of the laser beam may be lower in scanning the surface of the sealing plate than in scanning the surface of the lead.

Moreover, the vicinity of a portion irradiated with the laser beam on the surface of the sealing plate is preferably sprayed with a current of air when the surface of the sealing plate is scanned with the laser beam. In this method, when the surface of the sealing plate is irradiated with the laser beam, cooling by the current of air reduces the excessive temperature rise at the sealing plate. Thus, it is possible to prevent the melted portion from reaching the back side of the sealing plate. Alternatively, in order to obtain similar advantages, a jig having a higher thermal conductivity than that of the sealing plate may be brought into contact with the sealing plate in the vicinity of a portion irradiated with the laser beam on the surface of the sealing plate.

Moreover, the spot diameter of the laser beam is preferably in the range of ½- 1/10 of the thickness of the lead. With this method, it is possible to significantly reduce sputtered substances during welding by a laser beam, and thus a highly reliable sealed battery can be fabricated.

Embodiments of the present invention will be described hereinafter with reference to the drawings. It should be noted that the present invention is not limited to the following embodiments. Various changes and modifications may be made without departing from the scope of the present invention. The following embodiments may be combined as necessary.

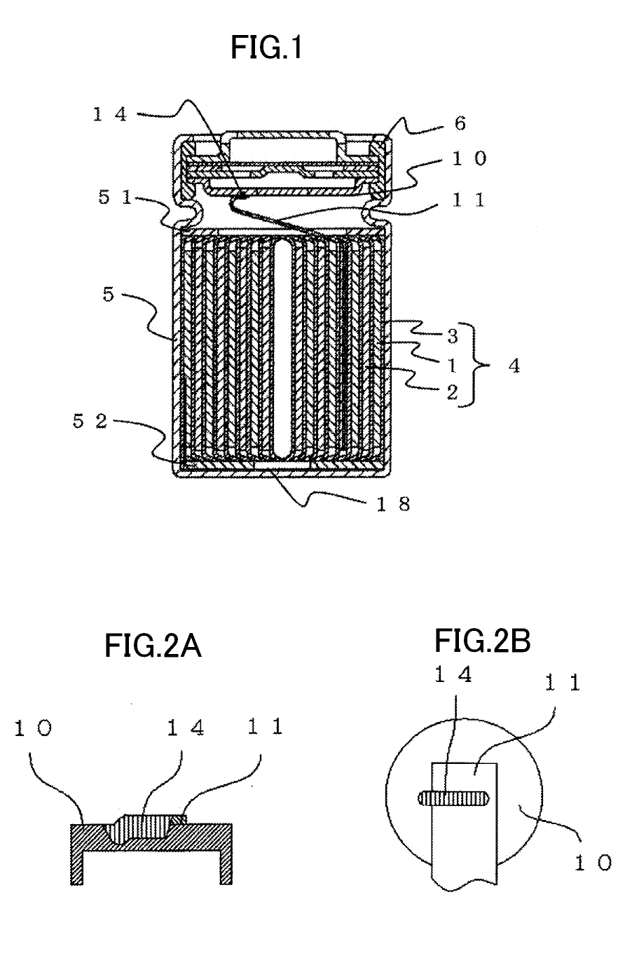

FIG. 1 is a cross-sectional view schematically illustrating a configuration of a sealed battery of an embodiment of the present invention. As illustrated in FIG. 1, an electrode group 4 formed by winding a positive electrode plate 1 and a negative electrode plate 2 with a separator 3 interposed between the positive electrode plate 1 and the negative electrode plate 2 is housed in a battery case 5 together with an electrolyte, with the electrode group being sandwiched between upper and lower insulating plates 51, 52. An opening of the battery case 5 is sealed with sealing plate 10 via a gasket 6. A lead 11 extending from one of the electrode plates in the electrode group 4 (for example, the positive electrode plate 1) is laser welded to the sealing plate 10. Here, part of a welding portion 14 also exists in a place where the lead 11 is not positioned, i.e., on a surface of the sealing plate 10, and thus extends on both a surface of the lead and the surface of the sealing plate.

The sealed battery of the embodiment of the present invention is fabricated as follows. First, a positive electrode plate 1 and a negative electrode plate 2 are stacked or wound with a separator interposed therebetween, thereby forming an electrode group 4. Then, the electrode group 4 is housed in battery case 5 with the electrode group 4 sandwiched between upper and lower insulating plates 51, 52. Next, one end of a lead 18 extending from a lower end portion of the electrode group 4 is welded to a bottom of the battery case 5. After that, one end of a lead 11 extending from an upper end portion of the electrode group 4 is brought into contact with a sealing plate 10, and in this state, the end of the laser 11 is laser welded to a bottom surface of the sealing plate 10, thereby forming a welding portion 14. Further, through an opening of the battery case 5, a nonaqueous electrolyte is injected, and the sealing plate 10 provided with a gasket 6 at its circumference is placed on the lead 11 while bending the lead 11. The opening of the battery case 5 is inwardly bent and crimped so that the battery case 5 is sealed. The sealed battery is thus formed.

FIG. 2A is a cross-sectional view illustrating a laser joint portion of the embodiment of the present invention. FIG. 2B is a plan view illustrating the laser joint portion. As illustrated in FIG. 2A, the welding portion 14 penetrates into the lead 11 and the sealing plate 10, thereby joining the lead 11 to the sealing plate 10. Moreover, as illustrated in FIG. 2B, the welding portion 14 extends on both the surface of the lead 11 and the surface of the sealing plate 10.

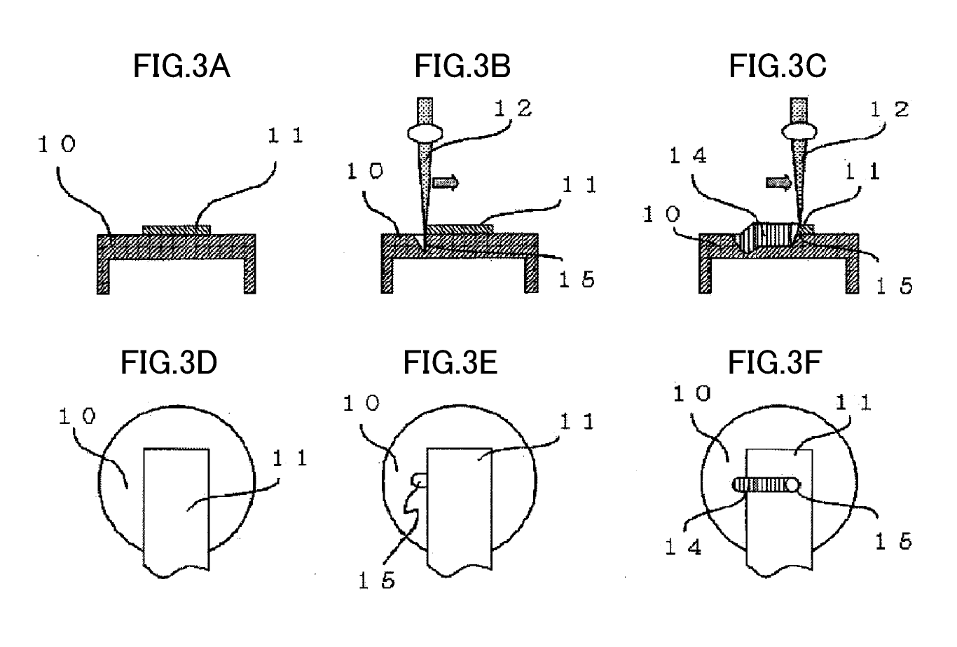

Laser welding of the lead 11 to the sealing plate 10 will be described in detail with reference to FIGS. 3A-3F. Here, FIGS. 3A-3C are cross-sectional views illustrating processes of the laser welding of the lead to the sealing plate of the embodiment of the present invention. FIGS. 3D-3F are plan views of the processes of FIGS. 3A-3C, respectively.

As illustrated in FIGS. 3A and 3D, an end portion of the lead 11 is disposed near the center of the sealing plate 10, where the lead 11 is brought into contact with the sealing plate 10 so that no gap is formed between the lead 11 and the sealing plate 10. Next, as illustrated in FIG. 3B, continuous scanning with a laser beam 12 having a spot diameter smaller than the thickness of the lead 11 is performed from a portion which is not provided with the lead 11, i.e., from the surface of the sealing plate 10, along the width direction of the lead 11 and toward the lead 11. Here, as illustrated in FIG. 3E, a melted portion 15 formed when the continuous scanning from the surface of the sealing plate 10 toward the lead 11 is started exists only in the surface of the sealing plate 10.

Further, as illustrated in FIG. 3C, the surface of the lead 11 is continuously scanned with the laser beam 12, and irradiation with the laser beam 12 is stopped before the scanning reaches the end portion of the lead 11. Since the laser beam 12 is moved, the melted portion 15 which the laser beam 12 has left cools to form a welding portion 14, and only the vicinity of an irradiated portion is the melted portion 15. The melted portion 15 also moves on the sealing plate 10 or the lead 11 as the laser beam 12 is moved. Here, as illustrated in FIG. 3F, the welding portion 14 extends on both the surface of the lead 11 and the surface of the sealing plate 10.

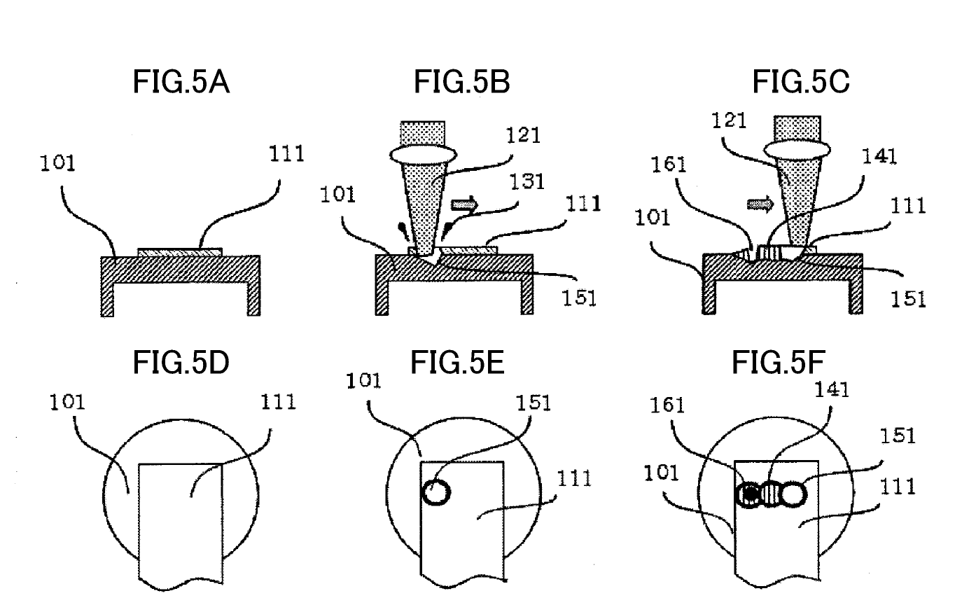

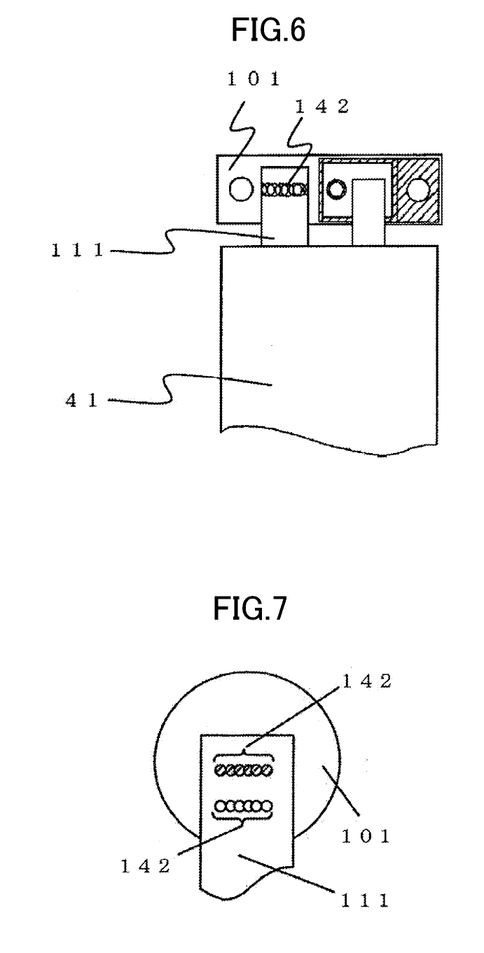

In this way, when an end of the lead 11 is irradiated with the laser beam 12 having a spot diameter smaller than the thickness of the lead 11, the melted portion 15 is much smaller than the melted portion 151 formed by the pulse oscillation YAG laser illustrated in FIG. 5C. Thus, sputtered substances are less likely to be produced, and no hole is formed. A welding mechanism in this case is as follows.

When irradiation with the laser beam 12 having a spot diameter smaller than the thickness of the lead 11 is continued, the energy of the laser beam 12 gradually increases the temperature of the lead 11 itself, so that a heated region is locally and rapidly melted, thereby forming the melted portion 15. Here, repulsive force at the time of evaporation of high-pressure plasma which is metal vapor of the melted lead 11 forms a slightly recessed portion referred to as a keyhole in a surface of the melted portion 15. Once the keyhole is formed, multiple reflection of the laser beam 12 occurs within the keyhole. Thus, the energy of the laser beam 12 is efficiently absorbed in the lead 11, so that the melting width and the melting depth rapidly increase.

The depth of the keyhole further increases, thereby welding the lead 11 to the sealing plate 10. Thereafter, the laser welding is continued under heat balance with a certain melting width and a certain melting depth. In this case, the energy of the irradiation with the laser beam 12 efficiently travels from the lead 11 to the sealing plate 10, and thus sputtered substances are reduced even when the end of the lead 11 is irradiated with the laser beam.

As described above, the welding portion 9 between the lead 11 and the sealing plate 10 is formed by deep penetration keyhole welding, and the melting width and the volume required for laser welding are significantly reduced. Moreover, in the keyhole welding, multiple reflection of the laser beam 12 occurs within the keyhole, so that input laser energy is efficiently absorbed in the lead 11 and the sealing plate 10.

Therefore, in the keyhole welding, the input laser energy can be reduced compared to welding of a heat conduction type such as welding using a pulse oscillation YAG laser (laser energy input in the lead 11 is thermally conducted via the lead 11 to the sealing plate 10, so that the lead 11 is welded to the sealing plate 10). Thus, the absolute amount of sputtered substances can be reduced.

Unlike the conventional example in which laser welding is performed only on the surface of the lead 11, welding in the present invention is performed such that a region longer than the surface of the lead 11, i.e., a region extending on both the surface of the lead 11 and the surface of the sealing plate 10 is scanned with the laser beam 12. In this way, even with a variation in external factors in fabrication processes (e.g., variations in position of the lead 11, or variations in position of irradiation with the laser beam 12), laser welding can be performed without being influenced by laser welding at the end portion of the lead 11, which is a major factor of sputtering. As a result, sputtered substances during the laser welding can be reduced, and the sputtered substances entering the battery case or attached to the gasket 6 provided at the circumference of the sealing plate 10 can significantly be reduced. Thus, it is possible to provide a highly reliable sealed battery in which formation of a hole in the lead 11 or the sealing plate is reduced, and which is less susceptible to joint strength degradation. Moreover, in terms of cost, fabrication using a low-price device is possible. In particular, the method is also applicable to a lead which is narrow due to advance of an increase in capacity, downsizing, and a reduction in thickness of the sealed battery. Thus, a high quality sealed battery can stably be fabricated by welding with sputtered substances being reduced while the joint strength is maintained.

Note that the spot diameter of the laser beam 12 in this method is smaller than the thickness of the lead 11, and is preferably about ½- 1/10 of the thickness of the lead 11. In order to achieve more stable keyhole welding, the spot diameter of the laser beam 12 is preferably ⅕- 1/10 of the thickness of the lead 11.

When the spot diameter of the laser beam 12 is larger than ½ of the thickness of the lead 11, the melted area is large, and the temperature of a heated region rapidly rises. This causes melted metal to be sputtered, making it difficult to reduce production of sputtered substances. In contrast, when the spot diameter of the laser beam 12 is smaller than 1/10 of the thickness of the lead 11, the welding strength between the sealing plate 10 and the lead 11 is deteriorated. Since the sealing plate 10 is placed on the opening of the battery case, the sealing plate 10 may be detached from the lead 11 when the lead 11 is bent.

For example, when the spot diameter has a value less than 0.2 mm, which is the thickness of the lead 11, keyhole welding with a large penetration depth can be performed. In particular, when the spot diameter is smaller than 0.04 mm to improve the power density, a keyhole is effectively formed. Thus, welding with a small melted area and deep penetration can be possible. In order to obtain such a small spot diameter, for example, a fiber laser in which an optical fiber itself serves as a laser oscillator can be used. Beam quality such as the angle of divergence form the fiber laser is very high, and thus it is possible to achieve a sufficiently small spot diameter. In the experiments by the present inventors, the spot diameter can be 0.1 mm, and when a condenser optical system is improved, the spot diameter can further be reduced to about 0.01 mm.

A conventional pulse oscillation YAG laser uses an optical fiber for transmission, and thus the light collection ability is low. Therefore, the spot diameter of the YAG laser is usually 0.6-0.8 mm, which is the same as or larger than the thickness of the lead 11, and is 0.3 mm at minimum. Thus, the melted portion 15 is formed in a large area of the end of the lead 11, resulting in welding of a heat conduction type, where no keyhole is formed.

In contrast, in the keyhole welding, heat in the periphery of a center portion of the melted portion 15 is dissipated, so that a rapid temperature rise does not occur. Therefore, melted metal is not partially sputtered, and sputtered substances are reduced. Thus, formation of a hole in the lead 11 or in the sealing plate 10 can be reduced. Therefore, in order to ensure the function as the sealed battery, the welding length can be long, and the lead 11 can be irradiated with a laser from its one end portion to its opposite end portion. As a result, a large area of the lead 11 can stably be welded, so that it is possible to increase the joint strength. Moreover, since the sealing plate 10 is placed on the opening of the battery case, the lead 11 is not detached from the sealing plate 10 when the lead 11 is bent or due to vibration.

Incidentally, the spot diameter of the laser beam 12 of the embodiment of the present invention is as small as about ½- 1/10 of the thickness of the lead 11. Thus, the joint strength might decrease as the welding area decreases. Accordingly, a large number of welded portions are necessary to ensure a sufficient joint strength. However, laser welding of a plurality of portions causes repetitive state changes among heating, melting, and solidification, resulting in that sputtering readily occurs. In addition, some welded portions are unstable, and as a result, a stable joint strength cannot be obtained.

In view of these problems, in order to obtain a stable joint structure without occurrence of sputtering, continuous scanning with a continuously oscillating laser beam 12 is performed to form a linear welding portion 14 on the surfaces of the lead 11 and the sealing plate 10 in the present invention. In this way, sputtered substances 13 can significantly be reduced with the joint strength being maintained.

Note that the welding length of the welding portion 14 is preferably four or more times the welding width of the welding portion 14. The joint strength correlates with a product of the length and the width of the welding portion 14, i.e., with the welding area, and thus it is preferable that the width of the welding portion 14 be basically small. Therefore, to ensure the joint strength even with the welding portion 14 having a small width, the welding length of the welding portion 14 is preferably four or more times the welding width of the welding portion 14. With this configuration, the welding strength between the sealing plate 10 and the lead 11 is not deteriorated, and the welding portion 14 between the lead 11 and the sealing plate 10 is not damaged when bending the lead 11 to place the sealing plate 10 on the opening of the battery case or due to vibration.

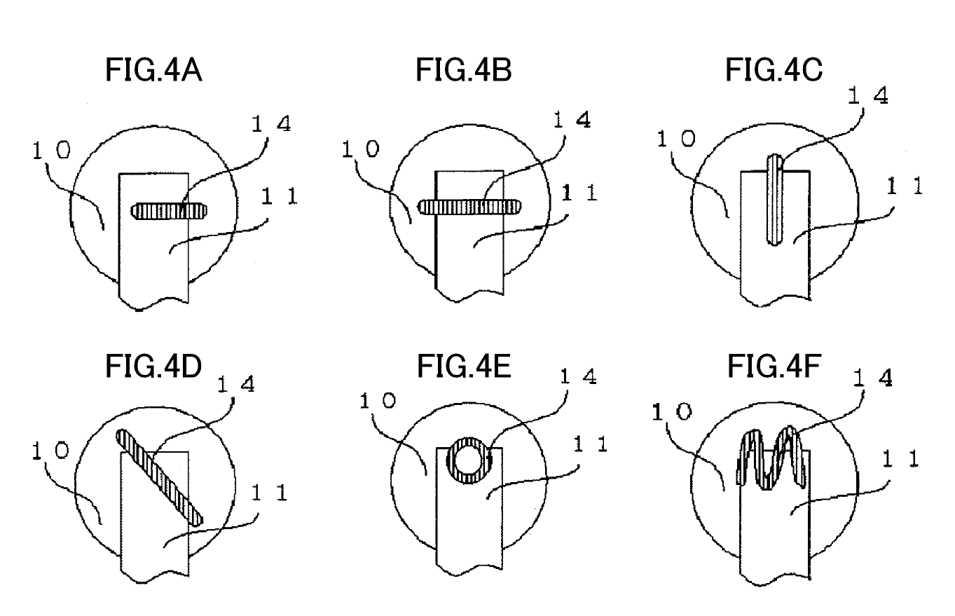

FIGS. 4A-4F are plan views illustrating configurations of welding potions between leads and sealing plates in other embodiments of the present invention.

In FIG. 4A, welding is started at a surface of a lead 11, and then the welding is terminated at a surface of a sealing plate 10. In FIG. 4B, welding is started at a position on a surface of a sealing plate 10, irradiation is performed on a surface of a lead 11, and then the welding is terminated at the opposite position on the surface of the sealing plate 10 via the lead 11. In FIG. 4C, a lead 11 is irradiated with a laser in parallel to the longitudinal direction of the lead 11, and a welding portion 14 is formed in a region extending on both the lead 11 and the sealing plate 10. In FIG. 4D, welding is diagonally performed on a surface of a lead 11, where a welding portion 14 is formed in a region, inclusive of a sealing plate 10, straddling the upper end side and the right end side of the lead 11. Alternatively, the welding portion 14 may have a circle shape as illustrated in FIG. 4E, or may have a bent shape as illustrated in FIG. 4F. Alternatively, the welding portion 14 may form a rectangular, elliptic, or arbitrary pattern. Alternatively, scanning with the laser beam 12 may be performed in a direction from the surface of the sealing plate 10 toward the surface of the lead 11, or in a direction from the surface of the lead 11 toward the surface of the sealing plate 10, or a combination of these directions may be possible.

### EXAMPLES

Examples in each of which a lithium ion secondary battery is used as a sealed battery of the present invention will be described below.

### First Example

A positive electrode plate 1 was formed as follows. First, 100 parts by weight of lithium cobaltate as an active material, 2 parts by weight of acetylene black as a conductive material, and 2 parts by weight of polyvinylidene fluoride (PVdF) as a binder were stirred in a kneader together with a proper amount of N-methyl-2-pyrrolidone, thereby preparing positive electrode mixture coating. Next, the positive electrode mixture coating was applied to both surfaces of a positive electrode current collector made of aluminum foil having a thickness of 15 μm, and the applied coating was dried. After that, the positive electrode current collector provided with the positive electrode mixture coating was pressed to have a total thickness of 165 μm, and then subjected to slit processing. The positive electrode plate 1 was thus formed.

Moreover, a negative electrode plate 2 was formed as follows. First, 100 parts by weight of artificial graphite as an active material, 2.5 parts by weight (1 part by weight in terms of solid content of a binder) of styrene-butadiene copolymer rubber particle dispersion (solid content 40 wt. %) as a binder, and 1 part by weight of carboxymethylcellulose as a thickening agent were stirred in a kneader together with a proper amount of water, thereby preparing negative electrode mixture coating. Next, the negative electrode mixture coating was applied to both surfaces of a negative electrode current collector made of copper foil having a thickness of 10 μm, and then the applied coating was dried. After that, the negative electrode current collector provided with the negative electrode mixture coating was pressed to have a total thickness of 180 μm, and then subjected to slit processing. The negative electrode plate 2 was thus formed.

The positive electrode plate 1 and the negative electrode plate 2 formed as described above were wound with a separator 3 interposed therebetween, thereby forming an electrode group 4, the separator 3 being made of a polyethylene microporous film having a thickness of 20 μm. The electrode group 4 was stored in a battery case 5, with the electrode group 4 sandwiched between insulating plates 51, 52. Next, one end of a lead 18 extending from an end portion of the negative electrode plate 2 in the electrode group 4 was resistance welded to a bottom of the battery case 5. Further, a lead 11 extending from the positive electrode plate 1 in the electrode group 4 and made of aluminum foil was continuously irradiated with a laser beam 12 with the lead 11 being in contact with a sealing plate 10 made of an aluminum plate. In this way, the lead 11 was welded to the sealing plate 10. Here, the lead 11 had a thickness of 0.15 mm, and a width of 4 mm. The sealing plate 10 had a diameter of 16.8 mm, and a thickness of 0.4 mm at its portion to which the lead 11 was joined. The laser beam had a spot diameter of 0.02 mm. Irradiation with the laser beam was started, as illustrated in FIG. 3B, from a surface of the sealing plate 10, and was terminated, as illustrated in FIG. 3C, at a position slightly left to the right end of the lead 11. As a result, a welding portion 14 was formed to have a melting width of 0.25 mm, a melting length of 2.2 mm, and a melting length of 0.2 mm on the surface of the sealing plate 10.

Next, a nonaqueous electrolyte was injected into the battery case 5. Then, the lead 11 was bent, and the sealing plate 10 was placed on an opening of the battery case 5. The opening of the battery case 5 was sealed by being crimped onto the sealing plate 10 via a gasket 6. In this way, a lithium ion secondary battery of a first example was fabricated.

### First Comparative Example

A lithium ion secondary battery of a first comparative example was fabricated by using an electrode group 4 formed in a manner similar to that of the first example, wherein a lead 111 was welded to a sealing plate 101, as illustrated in FIGS. 5B-5C, by using a pulsed YAG laser having a spot diameter of 0.4 mm.

In the first example, when the welding portion between the lead and the sealing plate was observed, no sputtered substances during laser welding were observed by eyes. Moreover, the surfaces of the sealing plate 10 and the surface the lead 11 were closely observed. No adhesion of the sputtered substances was observed, and no hole was formed in the welding portion 14. Here, the joint strength between the lead 11 and the sealing plate 10 was about 23 N. In contrast, in the first comparative example, a large amount of sputtered substances 131 during laser welding was observed by eyes, a large amount of the sputtered substances 131 adhered to the lead 111 and the sealing plate 101, and a hole 161 was formed in the welding portion 141. Here, the joint strength between the lead 111 and the sealing plate 101 was about 19 N.

The first example was compared with the first comparative example. Welding itself was implemented, and thus extraction of a current was possible in both of the examples. However, in the first example, no sputtered substances were produced, and thus a highly reliable sealed battery was obtained.

### Second Example

A lithium ion secondary battery of a second example was fabricated by using an electrode group 4 formed in a manner similar to that of the first example, and by performing laser welding in a similar manner to that of the first example except that the lead 11 had a width of 2 mm, and the welding portion 14 extended, as illustrated in FIG. 4B, on the surface of the lead 11 and the surface of the sealing plate 10 outside both ends of the lead 11.

### Second Comparative Example

A lithium ion secondary battery of a second comparative example was fabricated by performing laser welding in a similar manner to that of the second example except that a pulsed YAG laser having a spot diameter of 0.4 mm was used.

The welding portion between the lead and the sealing plate was observed. In the second example, no sputtered substances during the laser welding were observed by eyes. Moreover, the surfaces of the sealing plate 10 and the lead 11 were closely observed. No adhesion of the sputtered substances was observed, and no hole was formed in the welding portion 14. Here, the joint strength between the lead 11 and the sealing plate 10 was about 22 N. In contrast, in the second comparative example, a large amount of sputtered substances 131 during the laser welding was observed by eyes, a large amount of the sputtered substances 131 adhered to the lead 111 and the sealing plate 101, and a hole 161 was formed in the welding portion 141. Here, the joint strength between the lead 111 and the sealing plate 101 was about 13 N.

The second example was compared with the second comparative example. In second example, no sputtered substances were produced, and it was possible to reduce adhesion of the sputtered substances to the gasket or contamination by the sputtered substances entering the battery case in fabrication processes of the sealed battery. Moreover, the welding length of the second example was 2 mm, which was the same as that of the first example, and thus a joint strength which is the same as that of the first example can be obtained in the second example. The joint strength of the second comparative example is lower than that of the first comparative example due to formation of a hole. According to the second example, even with the small width of the lead 11, it was possible to reduce sputtered substances while maintaining the joint strength.

### Third Example

A lithium ion secondary battery was fabricated by using an electrode group 4 formed in a manner similar to that of the first example, and by performing laser welding in a manner similar to that of the first example except that the welding portion 14 had a melting width of 0.4 mm, and a melting length of 1.6 mm.

As a result, a stable joint strength of about 15 N was obtained. In view of this result, the ratio of the welding length to the welding width of the welding portion 14 having a linear shape is preferably greater than or equal to four.

The joint strength correlates with the product of the length and the welding width of the welding portion 14, that is, with the welding area. Provided that the welding width is constant, the joint strength correlates with the welding length. The welding width depends on the melted area during irradiation with the laser beam 12. The smaller the melted area is, the more sputtered substances can be reduced. Thus, it is preferable that the welding width be basically small. However, when the welding width is too small, it is difficult to ensure the joint strength. Thus, there is a suitable range for the ratio of the welding width to the welding length, and the ratio is preferably greater than or equal to four.

### Fourth Example

A lithium ion secondary battery was fabricated by using an electrode group 4 formed in a manner similar to that of the first example, and by performing laser welding in a manner similar to that of the first example except that the distance scanned per second with the laser beam 12 having a spot diameter of 0.02 mm was 10-500 mm.

As a result, when the distance scanned per second was greater than or equal to 50 mm, i.e., when the distance scanned per second was 2500 or more times the spot diameter of the laser beam 12, no sputtered substances were produced. In contrast, when laser welding was performed with the scanned distance that was less than 2500 times the spot diameter, sputtered substances were produced, and the welding width was large.

This is probably because when the distance scanned per second is less than 2500 times the spot diameter of the laser beam 12, the heat input per unit time is large, and thus the melted area is large, so that sputtered substances are more likely to be produced from the surface. The sputtered substances produced during laser welding closely relate to the spot diameter of the laser beam and to the moving distance of the laser beam. The distance scanned per second is preferably 2500 or more times the spot diameter of the laser beam.

### Fifth Example

A lithium ion secondary battery was fabricated by using an electrode group 4 formed in a manner similar to that of the first example, and by performing laser welding in a manner similar to that of the first example except that the scanning speed v1 for scanning the surface of the sealing plate 10 with the laser beam 12 was different from the scanning speed v2 for scanning the surface of the lead 11 with the laser beam 12.

It was observed whether or not sputtered substances were produced when the scanning speed v1 for scanning the surface of the sealing plate 10 with the laser beam 12 was 100 mm/second, and the scanning speed v2 for scanning the surface of the lead 11 with the laser beam 12 was 50 mm/second. The results showed that in any combination, no sputtered substances were produced. Therefore, the scanning speed of the laser beam is preferably higher in scanning the surface of the sealing plate 10 than in scanning the surface of the lead 11.

### Sixth Example

A lithium ion secondary battery was fabricated by using an electrode group 4 formed in a manner similar to that of the first example, and by performing laser welding in a similar manner to that of the first example except that the output p1 of the laser beam 12 in scanning the surface of the sealing plate 10 was different from the output p2 of the laser beam 12 in scanning the surface of the lead 11.

It was observed whether or not sputtered substances were produced when the output pl of the laser beam 12 in scanning the surface of the sealing plate 10 was 150-500 W, and the output p2 of the laser beam 12 in scanning the surface of the lead 11 was 500 W. The results showed that a few sputtered substances were produced only when the output p1 and the output p2 were both 500 W. Therefore, the output of the laser beam is preferably smaller in scanning the surface of the sealing plate 10 than in scanning the surface of the lead 11.

### Seventh Example

A lithium ion secondary battery was fabricated by using an electrode group 4 formed in a manner similar to that of the first example, and by performing laser welding in a manner similar to that of the first example except that the vicinity of a position irradiated with the laser beam 12 on the surface of the sealing plate 10 was sprayed with nitrogen gas at 10 L/minute from a nozzle tip with a diameter of 2 mm, and the scanning speed of the laser beam 12 was 50 mm/second.

As a result, no sputtered substances were observed at the welding portion between the lead and the sealing plate. Moreover, the atmospheric gas was changed to a helium and argon gas, and welding was performed in a similar manner. Likewise, no sputtered substances were produced. The vicinity of the position scanned with the laser beam on the surface of the lead is sprayed with a flow of the atmospheric gas, so that cooling by the flow of the atmospheric gas can reduce an excessive temperature rise at the sealing plate 10 and the lead 11, thereby reducing sputtered substances.

### Eighth Example

A lithium ion secondary battery was fabricated by using an electrode group 4 fabricated in a manner similar to that of the first example, and by performing laser welding in a same manner as in the first example except that a jig made of an aluminum plate was brought into area contact with the sealing plate 10 in the periphery of the melted portion 15 illustrated in FIG. 3E, and the scanning speed of the laser beam was 50 mm/second.

As a result, no sputtered substances were observed at the welding portion between the lead and the sealing plate. Moreover, laser welding was performed in a similar manner except that metal forming the jig brought into contact with the sealing plate 10 was copper and tungsten. Likewise, no sputtered substances were observed. A jig made of a metal having a high thermal conductivity is brought into contact with the vicinity of a position scanned with the laser beam 12 on the surface of the sealing plate 10, so that an excessive temperature rise at the sealing plate 10 can be reduced, and it is possible to reduce sputtered substances.

It should be recognized that the foregoing embodiments are only preferred examples of the present invention, and should not be taken as limiting the scope of the present invention, and various changes and modifications may be made. For example, in the above embodiments, the lead 11 and the sealing plate 10 are made of the same aluminum material. Alternatively, the lead 11 and the sealing plate 10 may be made of different types of metal. To seal the opening of the battery case 5, the sealing plate 10 to which the lead 11 is welded is not necessarily crimped onto the opening of the battery case 5, and may be welded to the opening of the battery case 5.

The type of a sealed battery according to the present invention is not specifically limited, and the present invention is also applicable not only to lithium-ion secondary batteries, but also to nickel-metal hydride storage batteries. Further, the present invention is applicable not only to cylindrical secondary batteries, but also to rectangular secondary batteries. The present invention is also applicable to primary batteries. The electrode group is not necessary formed by winding a positive electrode plate and a negative electrode plate with a separator interposed between the positive electrode plate and the negative electrode plate, and may be formed by stacking a positive electrode plate, a negative electrode plate, and a separator. Moreover, the present invention is applicable not only to primary or secondary batteries, but also to lap welding of thin plates in other devices.

### INDUSTRIAL APPLICABILITY

According to the present invention, a stable and highly reliable sealed battery can be obtained, and the present invention is applicable to power sources for driving mobile devices, and the like.

### DESCRIPTION OF REFERENCE CHARACTERS

1 Positive Electrode Plate

2 Negative Electrode Plate

3 Separator

4 Electrode Group

5 Battery Case

6 Gasket

10 Sealing Plate

11 Lead

12 Laser Beam

14 Welding Portion

15 Melted Portion

18 Lead

51, 52 Insulating Plate

1. A sealed battery comprising:
an electrode group formed by winding or stacking a positive electrode plate and a negative electrode plate with a separator interposed between the positive electrode plate and the negative electrode plate, the electrode group being housed in a battery case, and an opening of the battery case being sealed with a sealing plate, wherein
a lead extending from one of the electrode plates in the electrode group is laser welded to the sealing plate, and
a welding portion between the lead and the sealing plate has a linear shape straddling at least an end portion of the lead.

2. The sealed battery of claim 1, wherein
the lead is laser welded to the sealing plate by being continuously scanned with a laser beam having a spot diameter smaller than a thickness of the lead.

3. The sealed battery of claim 1, wherein
a ratio of a welding length to a welding width of the welding portion is greater than or equal to four.

4. The sealed battery of claim 1, wherein
the lead and the sealing plate are made of a material containing aluminum as a main component.

5. A method for fabricating a sealed battery, the method comprising:
forming an electrode group by winding or stacking a positive electrode plate and a negative electrode plate with a separator interposed between the positive electrode plate and the negative electrode plate;
connecting one end of a lead to one of the electrode plates in the electrode group;
housing the electrode group in a battery case;
laser welding the other end of the lead to a sealing plate by applying, to the lead, a laser beam having a spot diameter smaller than a thickness of the lead while continuously scanning the lead with the laser beam, with the other end brought into contact with the sealing plate; and
sealing an opening of the battery case with the sealing plate, wherein
the scanning with the laser beam starts at least from a surface of the sealing plate and reaches a surface of the lead via an end portion of the lead.

6. The method of claim 5, wherein
a light source of the laser beam is a fiber laser.

7. The method of claim 6, wherein
a distance scanned with the laser beam per second is 2500 or more times the spot diameter of the laser beam.

8. The method of claim 5, wherein
a scanning speed of the laser beam is higher in scanning the surface of the sealing plate than in scanning the surface of the lead.

9. The method of claim 5, wherein
an output of the laser beam is lower in scanning the surface of the sealing plate than in scanning the surface of the lead.

10. The method of claim 5, wherein
a vicinity of a portion irradiated with the laser beam on the surface of the sealing plate is sprayed with a current of air when the surface of the sealing plate is scanned with the laser beam.

11. The method of claim 5, wherein
a jig having a higher thermal conductivity than that of the sealing plate is brought into contact with the sealing plate in a vicinity of a portion irradiated with the laser beam on the surface of the sealing plate.

12. The method of claim 5, wherein
the spot diameter of the laser beam is in the range of ½- 1/10 of the thickness of the lead.
